(19) United States
(12) Patent Application Publication
(10) Pub. No.: US 2004/0063848 A1
(43) Pub. Date: Apr. 1, 2004

(54) Oligomeric dyes and preparation thereof

(75) Inventors: David B. Olson, Marine on St. Croix, MN (US); David M. Burns, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/241,900

(22) Filed: Sep. 12, 2002

(51) Int. Cl. C08L 31/00

(52) U.S. Cl. 524/556; 525/329.7; 524/563; 8/550

(57) ABSTRACT

The invention provides a method for preparing an oligomeric dye by reacting a first component oligomer, having a carbon-carbon backbone, comprising a plurality of polymerized monomer units comprising pendant reactive nucleophilic or electrophilic functional groups; and a dye component having a co-reactive functional group.

These oligomeric dyes are suitable for use as additives to impart coloration or fluorescence to thermoplastic polymers, particularly olefinic polymers. The oligomeric dyes of the present invention advantageously are compatible in polymers where conventional dyes often have poor compatibility or solubility.

### FIELD OF INVENTION

This invention relates to oligomeric dyes. More particularly, this invention relates to fluorescent and non-fluorescent oligomeric dyes, a method for preparation and use thereof.

### BACKGROUND OF THE INVENTION

Polymeric articles such as films, coatings, or fibers are frequently colored using pigments or dyes. The conventional difference between a pigment and a dye is that dyes are soluble in the polymer matrix where they are placed, and are thus not aggregated, while pigments are insoluble in the polymer matrix, and thus can be aggregated in the polymer matrix.

Organic dyes, especially fluorescent dyes, are frequently large polyaromatic molecules that have poor compatibility with many polymer matrices. This is especially true for olefin-type polymers. Thus, many commercial applications using fluorescent technology use fluorescent pigments to allow them to be adequately dispersed in the polymers. Unfortunately, these articles often have poor color saturation and diminished edge-glow effect.

Thus, the need exists for dyes having improved compatibility with polymer matrices and a method of making such dyes.

### SUMMARY OF THE INVENTION

The present invention provides oligomeric dyes. These oligomeric dyes are suitable for use as additives to impart coloration or fluorescence to thermoplastic polymers, particularly olefinic polymers. The oligomeric dyes of the present invention advantageously are compatible in polymers where conventional dyes often have poor compatibility or solubility. Further, the oligomeric dyes provide enhanced “edge-glow”, i.e. emit more light from the edges or ends than from the planar surfaces of films.

In one aspect, this invention provides a method for preparing an oligomeric dye by reacting:

a) a first component oligomer, having a carbon-carbon backbone, comprising a plurality of polymerized monomer units comprising pendant reactive nucleophilic or electrophilic functional groups;

b) a second dye component having a co-reactive functional group; and

c) optionally a third aliphatic component having a co-reactive functional group.

Briefly, the present invention provides oligomeric dyes prepared from a first oligomer containing reactive functional groups capable of reaction at effective rates (at normal processing temperatures) with a co-reactive second dye component possessing functionality that is complementary to that of the first oligomer. By complementary is meant that if the oligomer's reactive functional groups are electrophilic in nature, the second dye component should possess co-reactive nucleophilic groups. The converse is also useful; when the oligomer contains reactive nucleophilic groups then the second component contains co-reactive electrophilic groups. In addition, reactions involving oligomeric reactants of the instant invention are controlled and precise in that they result in coupling reactions only by reaction between the reactive and co-reactive functional groups. The co-reactive second dye component may have a fluorescent or non-fluorescent dye moiety.

In another aspect, this invention provides an oligomeric dye composition by a process that incorporates a dye moiety and produces no or minimal by-products on reaction. This invention has several advantages. The composition is low in viscosity, readily melt processible and coatable, and has minimal residuals content such as solvents, monomers, plasticizers and/or viscosity modifiers. The compositions can be rapidly and reliably prepared without requiring specialized equipment and without generating concerns about potentially toxic or irritating unreacted low molecular weight monomeric species or reaction products.

In another aspect, the present invention provides a polymer composition prepared by combining the aforementioned oligomeric dye and a thermoplastic polymer. Advantageously, the oligomeric dye may be used to impart color or fluorescent properties to thermoplastics that are otherwise difficult to dye, due to the incompatibility of conventional dyes with the polymer matrix. Further, due to the compatibility and relatively high molecular weight (as compared to conventional non-oligomeric dyes), the dyed polymer is resistant to leaching and blooming.

The ability to vary the monomer composition of the oligomer and the degree of substitution by the dye moiety permits the modification of properties suitable for the various applications described previously. For example, the monomer composition of the oligomeric dye may be selected to provide compatibility with a chosen thermoplastic polymer. The oligomeric dyes of the present invention cure by means of reactive and co-reactive functional groups to form oligomeric dye compositions possessing tailorable properties such as color density or compatibility with a polymer matrix, for example, through selection of the monomer content, particular constituents, and by control of the degree of substitution. While the requirements for oligomeric dyes as polymer melt additives may vary, the structure of the oligomer and density of linkages can be altered while still maintaining the same method of forming oligomeric compositions. The maximum substitution density is predetermined by the percentage of functional groups incorporated into the oligomeric composition.

The present invention also provides oligomeric dyes while avoiding the problem of polymerizing a monomer having a dye moiety, which may have low reactivity and non readily polymerizable.

Further, the purity of the oligomeric dyes may be also important to produce high quality materials. Polymers used for fibers are often desirably delivered without significant amounts of volatile materials (such as monomeric species) to eliminate any contamination. However, the problems of residual volatile materials constitute a much more formidable challenge especially when acceptable limits of migratable, volatile impurities are on the order of a few parts per million. Industries such as medical, textile and food packaging require materials of high purity and lower cost. The composition of the present invention avoids problems due to species contamination, having a residuals content (i.e. unreacted monomers and/or unreacted or unincorporated dye molecules) of less than 2 weight percent, preferably less than 1 weight percent.

### DETAILED DESCRIPTION

The present invention provides oligomeric dyes useful as additives in the preparation of fibers, coatings, blown microfibers, foams, and films. The oligomeric dyes are prepared from oligomers having pendent reactive functional groups that are formed from ethylenically unsaturated monomers having reactive functional groups. The oligomeric dyes comprise the reaction product of a first component oligomeric addition polymer having one or more pendant reactive functional groups; and a second component dye having a co-reactive functional group. The dye moiety may be a fluorescent or non-fluorescent dye moiety. The oligomeric dyes comprise, per 100 parts by weight of a first component oligomer, a sufficient amount of said second component dye to provide at least one pendant dye moiety per first component oligomer chain. If desired, the oligomeric dye may further comprise pendant aliphatic groups derived from a third component aliphatic compound having a functional group that is co-reactive with the reactive functional group of the first component oligomer.

Useful second component dyes comprise compounds having a dye moiety and a co-reactive functional group capable of reacting with the pendent reactive functional group of the first component oligomer. The dye moiety may be any group that imparts color to a substance or substrate by selective absorption of light. The dye moiety may be any chromophore that absorbs and/or emits light in the visible region.

Useful functional groups of the second component dye capable of further reaction with the pendent reactive functional group of the first component oligomer such as a hydroxyl, amino, azlactone, oxazolinyl, 3-oxobutanoyl (i.e., acetoacetyl), carboxyl, isocyanato, epoxy, aziridinyl, acyl halide, vinyloxy, or cyclic anhydride group. Such functional groups are described in more detail below.

Useful non-fluorescent dye moieties include azo, heterocyclic azo, anthraquinone, benzodifuranone, polycyclic aromatic carbonyl, polymethine, styryl, di- and tri-aryl carbonium, phthalocyanine, indigoid, quinophthalone, nito, nitroso, stilbene, formazan and sulfur dye moieties. Useful fluorescent dye moieties include coumarin, thioxanthene, xanthene, naphthalic acid derivatives, perylene, perylene imide, benzanthrone, benzothioxanthone, diketopyrrole, rhodamine, cationic methane, thioindigoid, naphthalimide and azomethine moieties.

Useful functional monomers of the first component oligomer (having a pendent reactive functional group) include those unsaturated aliphatic, cycloaliphatic, and aromatic compounds having up to about 36 carbon atoms that include a functional group capable of further reaction, such as a hydroxyl, amino, azlactone, oxazolinyl, 3-oxobutanoyl (i.e., acetoacetyl), carboxyl, isocyanato, epoxy, aziridinyl, acyl halide, vinyloxy, or cyclic anhydride group.

Preferred functional monomers have the general formula

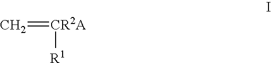

wherein R¹ is hydrogen, a C₁ to C₄ alkyl group, or a phenyl group, preferably hydrogen or a methyl group; R² is a single bond or a divalent linking group that joins an ethylenically unsaturated group to functional group A and contains up to 34, preferably up to 18, more preferably up to 10, carbon and, optionally, oxygen and nitrogen atoms and, when R² is not a single bond, is preferably selected from —R³—, —CO₂—, —CONH—, and combinations thereof, e.g. —CO₂—R³—, in which R³ is an alkylene group having 1 to 6 carbon atoms, a 5- or 6-membered cycloalkylene group having 5 to 10 carbon atoms, or an alkylene-oxyalkylene in which each alkylene includes 1 to 6 carbon atoms or is a divalent aromatic group having 6 to 16 carbon atoms; and A is a functional group, capable of reaction with a co-reactive functional group (of the second component dye) to form a covalent bond, preferably selected from the class consisting of hydroxyl, amino (including secondary amino), carboxyl, ester, isocyanato, aziridinyl, epoxy, acyl halide, vinyloxy, azlactone, oxazolinyl, acetoacetyl, and cyclic anhydride groups. Preferably Formula I represents an ethylenically unsaturated carboxylic acid or reactive functional derivative thereof, such as an acyl halide, ester, or anhydride.

Representative hydroxyl group-substituted functional monomers include the hydroxyalkyl (meth)acrylates and hydroxyalkyl (meth)acrylamides such as 2-hydroxyethyl (meth)acrylate, 2-hydroxypropyl (meth)acrylate, 3-chloro-2-hydroxypropylmethyl (meth)acrylate, 2-hydroxyethyl (meth)acrylamide, 4-hydroxycyclohexyl (meth)acrylate, 3-acryloyloxyphenol, 2-(4-acryloyloxyphenyl)-2-(4-hydroxyphenyl)propane (also called bisphenol A monoacrylate), 2-propyn-1-ol, and 3-butyn-1-ol.

Representative amino group-substituted functional monomers include 2-methyl aminoethyl methacrylate, 3-aminopropyl methacrylate, 4-aminocyclohexyl methacrylate, N-(3-aminophenyl)acrylamide, 4-aminostyrene, N-acryloylethylenediamine, and 4-aminophenyl-4-acrylamidophenylsulfone.

Representative azlactone group-substituted functional monomers include 2-ethenyl-1,3-oxazolin-5-one; 2-ethenyl-4-methyl-1,3-oxazolin-5-one; 2-isopropenyl-1,3-oxazolin-5-one; 2-isopropenyl-4-methyl-1,3-oxazolin-5-one; 2-ethenyl-4,4-dimethyl-1,3-oxazolin-5-one; 2-isopropenyl-4,4-dimethyl-1,3-oxazolin-5-one; 2-ethenyl-4-methyl-4-ethyl-1,3-oxazolin-5-one; 2-isopropenyl-3-oxa-1-aza[4.5] spirodec-1-ene-4-one; 2-ethenyl-5,6-dihydro-4H-1,3-oxazin-6-one; 2-ethenyl-4,5,6,7-tetrahydro-1,3-oxazepin-7-one; 2-isopropenyl-5,6-dihydro-5,5-di(2-methylphenyl)-4H-1,3-oxazin-6-one; 2-acryloyloxy-1,3-oxazolin-5-one; 2-(2-acryloyloxy)ethyl-4,4-dimethyl-1,3-oxazolin-5-one; 2-ethenyl-4,5-dihydro-6H-1,3-oxazin-6-one, and 2-ethenyl-4,5-dihydro-4,4-dimethyl-6H-1,3-oxazin-6-one.

Representative oxazolinyl group-substituted functional monomers include 2-vinyl-2-oxazoline, 2-isopropenyl-2-oxazoline, 2-(5-hexenyl)-2-oxazoline, 2-acryloxy-2-oxazoline, 2-(4-acryloxyphenyl)-2-oxazoline, and 2-methacryloxy-2-oxazoline.

Representative acetoacetyl group-substituted functional monomers include 2-(acetoacetoxy)ethyl (meth)acrylate, styryl acetoacetate, isopropenyl acetoacetate, and hex-5-enyl acetoacetate.

Representative carboxyl group-substituted functional monomers include (meth)acrylic acid, 3-(meth)acryloyloxy-propionic acid, 4-(meth)acryloyloxy-butyric acid, 2-(meth)acryloyloxy-benzoic acid, 3-(meth)acryloyloxy-5-methyl benzoic acid, 4-(meth)acryloyloxymethyl-benzoic acid, phthalic acid mono-[2-(meth)acryloyloxy-ethyl] ester, 2-butynoic acid, and 4-pentynoic acid.

Representative isocyanate group-substituted functional monomers include 2-isocyanatoethyl (meth)acrylate, 3-isocyanatopropyl (meth)acrylate, 4-isocyanatocyclohexyl (meth)acrylate, 4-isocyanatostyrene, 2-methyl-2-propenoyl isocyanate, 4-(2-acryloyloxyethoxycarbonylamino)phenylisocyanate, allyl 2-isocyanatoethylether, and 3-isocyanato-1-propene.

Representative epoxy group-substituted functional monomers include glycidyl (meth)acrylate, thioglycidyl (meth)acrylate, 3-(2,3-epoxypropxy)phenyl (meth)acrylate, 2-[4-(2,3-epoxypropoxy)phenyl]-2-(4-acryloyloxy-phenyl)propane, 4-(2,3-epoxypropoxy)cyclohexyl (meth)acrylate, 2,3-epoxycyclohexyl (meth)acrylate, and 3,4-epoxycyclohexyl (meth)acrylate.

Representative aziridinyl group-substituted functional monomers include N-(meth)acryloylaziridine, 2-(1-aziridinyl)ethyl (meth)acrylate, 4-(1-aziridinyl)butyl (meth)acrylate, 2-[2-(1-aziridinyl)ethoxy]ethyl (meth)acryl ate, 2-[2-(1-aziridinyl)ethoxycarbonylamino]ethyl (meth)acrylate, 12-[2-(2,2,3,3-tetramethyl-1-aziridinyl)ethoxycarbonylamino] dodecyl (meth)acrylate, and 2-(2-propenyl)aziridine.

Representative acyl halide group-substituted functional monomers include (meth)acryloyl chloride, α-chloroacryloyl chloride, acryloyloxyacetyl chloride, 5-hexenoyl chloride, 2-(acryloyloxy) propionyl chloride, 3-(acryloylthioxy) propionoyl chloride, and 3-(N-acryloyl-N-methylamino) propionoyl chloride.

Representative vinyloxy group-substituted functional monomers include 2-(ethenyloxy)ethyl (meth)acrylate, 3-(ethynyloxy)-1-propene, 4-(ethynyloxy)-1-butene, and 4-(ethenyloxy)butyl-2-acrylamido-2,2-dimethylacetate.

Representative anhydride group-substituted functional monomers include maleic anhydride, acrylic anhydride, itaconic anhydride, 3-acryloyloxyphthalic anhydride, and 2-methacryloxycyclohexanedicarboxylic acid anhydride.

The first component oligomer may further comprise other ethylenically unsaturated monomers selected to impart desirable physical properties such as T_{g}, or compatibility with a specific thermoplastic. Useful other monomers include olefins such as ethylene, propylene, butylene, and butene-1. Other useful monomers include those which are copolymerizable with the functional monomers and include ethylene, propylene, 1-butene, 1-pentene, 1-octene, 1-hexene, 4-methyl-1-pentene, propylene, vinyl ester monomers such as vinyl acetate, vinyl propionate, vinyl butyrate, vinyl chloroacetate, vinyl chloropropionate, acrylic and alkyl esters and amides of alpha-alkyl acrylic acid monomers, and nitriles such as acrylic acid, methacrylic acid, ethacrylic acid, methyl acrylate, ethyl acrylate, N,N-dimethyl acrylamide, methacrylamide, acrylonitrile, vinyl aryl monomers such as styrene, o-methoxystyrene, p-methoxystyrene, and vinyl naphthalene, vinyl and vinylidene halide monomers such as vinyl chloride, vinylidene chloride, vinylidene bromide, alkyl ester monomers of maleic and fumaric acid such as dimethyl maleate, diethyl maleate, vinyl alkyl ether monomers such as vinyl methyl ether, vinyl ethyl ether, vinyl isobutyl ether, 2-chloroethyl vinyl ether, and vinyl pyridine monomers.

Preferred other monomers are olefin monomers including ethylene, propylene, 1-butene, 3-methylbutene, 4-methylpentene and mixtures thereof.

In one embodiment the first component oligomeric addition polymer comprises oligomers of Formula II.

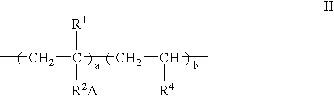

wherein R′ is hydrogen, a C₁ to C₄ alkyl group, or a phenyl group; R² is a single bond or a divalent linking group that joins an ethylenically unsaturated group to reactive functional group A; A is a reactive functional group, capable of reacting with a co-reactive functional group for the incorporation of a dye moiety, R⁴ is H or a C₁ to C₈ alkyl, a is at least one and a+b is 20 to 200 preferably 25 to 100. Preferably a and b are each at least one. It will be further understood that the polymerized monomer units of Formula II may be in any order and may comprise random or block polymerized monomer units shown.

With reference to Formula II, the first component oligomer may comprise

(1) from 1 to 25 parts by weight of polymerized monomer units having a pendent functional group (as described in Formula I); and

(2) from 50 to 99 parts by weight of a polymerized monomer units derived from an ethylenically-unsaturated monomer.

The first component oligomers have relatively low molecular weight. As result of the relatively low molecular weight, the oligomers are easily processible in operations such as coating, spraying, extrusion and injection molding, because of the low melt viscosity, and without the need for solvents, plasticizers or viscosity modifiers.

The molecular weight of the first component oligomer is generally between 500 and 15,000 Mw, and preferably less than 10,000 and more preferably less than 3000 Above this molecular weight the viscosity of the oligomer is such that coating is very difficult without the use of solvents, viscosity modifiers or plasticizers. If desired, higher molecular weight polymers may be blended with lower molecular weight oligomers so that the mixture has a viscosity of 500 to 10,000 cPs at 22° C. Oligomers have a degree of polymerization generally less than about 200.

Molecular weight may be controlled through the use of chain transfer agents, including mercaptans, disulfides, carbon tetrabromide, carbon tetrachloride, and others such as are known in the art. Useful chain transfer agents also include cobalt chelates, as described in U.S. Pat. Nos. 4,680,352 and 4,694,054.

It will be understood in the context of the above description of the first and second components, that the ethylenically-unsaturated monomer possessing a reactive functional group (“reactive monomer”) is chosen such that the first and second components are mutually co-reactive so that the first component oligomer has a pendant functional group that is co-reactive with the pendant functional group of the second component dye. The reactive and co-reactive functional groups form a bond between the first and second components by forming a linking group between the electrophilic and nucleophilic functional group pairs, and may include reactions commonly referred to as displacement, condensation and addition reactions, rather than polymerization of ethylenically-unsaturated groups. The second ethylenically unsaturated monomer, if present, is used to impart desired physical properties such as T_{g} to the oligomer, or to impart compatibility with another polymer.

While it is within the scope of the invention to employ nucleophile-electrophile combinations that react by displacement of some leaving group and creation of a by-product molecule, the removal of by-products may require an additional processing step. In some embodiments it may be preferred that the nucleophile-electrophile combinations react by an addition reaction in which no by-product molecules are created, and the exemplified reaction partners react by this embodiment. Exemplary combinations include hydroxyl or amino functional groups reacting with azlactone-, isocyanate-, and anhydride-functional groups and carboxyl groups reacting with isocyanate- and oxazoline-functional groups.

To aid in the understanding of this interaction between reactive first and co-reactive second functional groups, Table 1 summarizes some possible combinations of functional groups, using carboxyl and hydroxyl groups as representative examples. Those skilled in the art will readily recognize how other previously described functional groups also can be used to form covalent linking groups. It will be understood that the particularly functional groups listed may be used either with the first component oligomer or the second component dye.

TABLE I

| | | Co-reactive | | Resultant linking group |
|---|---|---|---|---|
| Functional group | | functional group | | “Q” |
| carboxyl | 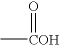 | oxazolinyl | 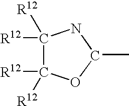 | 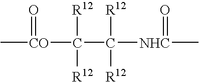 |
| | | aziridinyl | 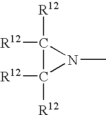 | 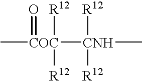 |
| | | epoxy | 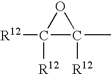 | 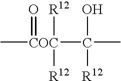 |
| | | hydroxyl | —OH | —CO₂— |
| hydroxyl | —OH | isocyanato | O═C═N— | 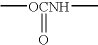 |
| | | acid halide | 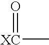 | 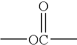 |
| | | azlactone | 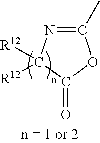 | 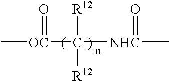 |
| | | (thio)epoxy | 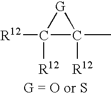 | 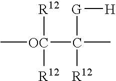 |

In Table 1, each R ¹² is independently hydrogen, an alkyl group having 1 to 4 carbon atoms, or a phenyl group.

It will be understood, with respect to the above-described co-reactive functional groups of the dye, that many common commercially available dyes may be modified by means known in the art to add a desired functional group thereto. For example, a common fluorescent yellow green dye, CI Solvent Yellow 98 (SY98, Hoechst Celanese, Charlotte, N.C.) having the structural formula

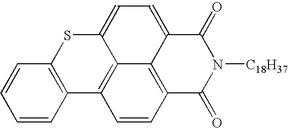

lends itself to simple structural modification through the anhydride precursor. Hydroxy functional dyes that are modifications of CI Solvent Yellow 98 have been prepared.

As previously described, the oligomeric dyes comprise the reaction product of a first oligomer component with a plurality of pendent reactive functional groups, a second dye component with a pendent co-reactive functional group, and optionally a catalyst. The physical form of the composition may be a viscous liquid or low melting solid or a powder, which is related to the glass transition temperature and the molecular weight. The glass transition temperature and molecular weight of the components may be adjusted to obtain compositions having desired properties useful for a myriad of applications ranging from fibers, fabrics, films, and tapes. Liquid oligomers or low melting solids may be obtained if the glass transition temperature of the oligomer component is below ambient temperature and the degree of polymerization of less than about 200, generally 20 to 200. Powders may be obtained when the T_{g} is above ambient temperature.

The first component oligomer may be prepared (e.g., by solution polymerization followed by isolation) and subsequently combined with a separately prepared second dye component. Any residual monomer and/or solvents used in the preparation are generally removed by conventional techniques such as distillation, vacuum evaporation, etc. The polymerizations may be conducted in the presence of suitable solvents such as ethyl acetate, toluene and tetrahydrofuran that are unreactive with the functional groups of the components of the first and second components.

Oligomerization to prepare the first component oligomer can be accomplished by exposing the component monomers to energy in the presence of a photoinitiator. Energy activated initiators may be unnecessary where, for example, ionizing radiation is used to initiate polymerization. These photoinitiators can be employed in concentrations ranging from about 0.0001 to about 3.0 pbw, preferably from about 0.001 to about 1.0 pbw, and more preferably from-about 0.005 to about 0.5 pbw, per 100 pbw of the composition. Alternatively, the oligomers may be prepared by reacting the monomers in the presence of a chain transfer agent and a free radical catalyst at a temperature between about 100° C. and 300° C. and at a pressure between 100 and 1000 atmospheres with turbulent agitation within an enclosed enlarged reaction zone. Reference may be made to U.S. Pat. No. 3,658,741, the disclosure of which is incorporated by reference.

A chain transfer agent may be used in an amount sufficient to control the number of polymerized monomer units in the oligomer, i.e. below 200. The chain transfer agent is generally used in an amount of about 0.05 to about 0.5 equivalents, preferably about 0.25 equivalents, per equivalent of olefinic monomer.

Chain-transfer agents are those that contain a group capable of terminating a radical chain reaction (e.g., a sulfhydryl) but no further functional groups capable of reacting with nucleophiles, electrophiles, or capable of undergoing displacement reactions. Such compounds include mono, di, and polythiols such as ethanethiol, propanethiol, butanethiol, hexanethiol, n-octylthiol, t-dodecylthiol, 2-mercaptoethyl ether, 2-mercaptoimidazole, 2-mercaptoethylsulfide, 2-mercaptoimidazole, 8-mercaptomenthone, 2,5-dimercapto-1,3,4-thiadiazole, 3,4-toluenedithiol, o-, m-, and p-thiocresol, ethylcyclohexanedithiol, p-menthane-2,9-dithiol, 1,2-ethanedithiol, 2-mercaptopyrimidine, and the like.

Useful initiators include persulfates, azo compounds such as azoisobutyronitrile and azo-2-cyanovaleric acid and the like, hydroperoxides such as cumene, t-butyl, and t-amyl hydroperoxide, dialkyl peroxides such as di-t-butyl and dicumyl peroxide, peroxyesters such as t-butyl perbenzoate and di-t-butylperoxy phthalate, diacylperoxides such as benzoyl peroxide and lauroyl peroxide.

The initiating radical formed by an initiator can be incorporated into the first component oligomer to varying degrees depending on the type and amount of initiator used. A suitable amount of initiator depends on the particular initiator and other reactants being used. About 0.1 percent to about 5 percent, preferably about 0.1 percent, to about 0.8 percent, and most preferably about 0.2 percent to 0.5 percent by weight of an initiator can be used, based on the total weight of all other reactants in the reaction.

The oligomerization reaction to produce the first component oligomer may be neat or carried out in any solvent suitable for organic free-radical reactions. The reactants can be present in the solvent at any suitable concentration, e.g., from about 5 percent to about 90 percent by weight based on the total weight of the reaction mixture. Examples of suitable solvents include aliphatic and alicyclic hydrocarbons (e.g., hexane, heptane, cyclohexane), aromatic solvents (e.g., benzene, toluene, xylene), ethers (e.g., diethylether, glyme, diglyme, diisopropyl ether), esters (e.g., ethyl acetate, butyl acetate), alcohols (e.g., ethanol, isopropyl alcohol), ketones (e.g., acetone, methyl ethyl ketone, methyl isobutyl ketone), sulfoxides (e.g., dimethyl sulfoxide), amides (e.g., N,N-dimethylformamide, N,N-dimethylacetamide), halogenated solvents such as methylchloroform, FREON™ 113, trichloroethylene, α, α, α.-trifluorotoluene, fluorinated ethers such as C₄F₉OCH₃ and the like, and mixtures thereof.

The oligomerization can be carried out at any temperature suitable for conducting an organic free-radical reaction. Particular temperature and solvents for use can be easily selected by those skilled in the art based on considerations such as the solubility of reagents, the temperature required for the use of a particular initiator, and the like. While it is not practical to enumerate a particular temperature suitable for all initiators and all solvents, generally suitable temperatures are between about 30° C. and about 200° C.

The oligomeric dye may be prepared by combining the first component oligomer and the second component dye at temperatures and for times sufficient to effect a reaction (and forming a covalent bond) between the reactive and co-reactive functional groups of the respective components. The relative amounts of the reactive and co-reactive functional groups may vary widely; from about 10:1 to 1:10 on a molar basis.

The reaction may be depicted in the following scheme where the first component oligomer having a pendant, reactive functional group A is reacted with a second component dye have a co-reactive functional group A′, to form an oligomeric dye having a pendent dye moiety linked to the oligomer by linking group Q. R′, R², R⁴, A, A′, a, b and c are as previously defined.

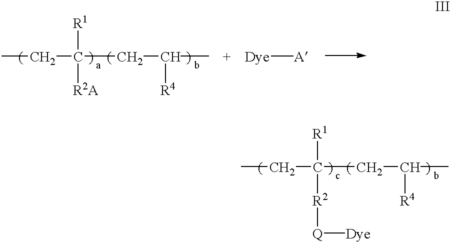

In one embodiment, the amount of the second component is in excess in order to fully functionalized the pendent reactive functional groups of the first component oligomer with a dye moiety. Upon completion, the resultant oligomeric dye may be separated from the unreacted second component dye, which may be recovered and recycled. It is preferred that the ratio of reactive functional groups (of the oligomer) to the co-reactive functional groups (of the dye) be from 1:1 to 10:1 to reduce or eliminate any unreacted dye. It will be apparent that the oligomeric dye may contain pendant, unreactive functional groups as result of using less than a stoichiometric amount of dye to produce oligomeric dyes of the formula:

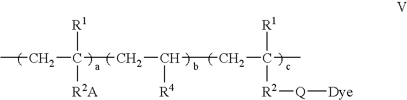

wherein R¹ is hydrogen, a C₁ to C₄ alkyl group, or a phenyl group; R² is a single bond or a divalent linking group that joins an ethylenically unsaturated group to reactive functional group A; R⁴ is H or a C₁ to C₈ alkyl, Q is the resulting divalent linking group formed by the reaction between the reactive and co-reactive functional groups, “Dye” is a fluorescent or non-fluorescent dye moiety, but preferably a fluorescent dye moiety; a is zero to 20, b is zero to 100, c is at least one and a+b+c is 20 to 200, preferably 25 to 100. Preferably a is 1 to 20, b is 1 to 100, c is at least one. It will be further understood that the polymerized monomer units of Formula V may be in any order and may comprise random or block polymerized monomer units shown.

The first component oligomer may further be reacted with sufficient amount of a third component aliphatic compound to provide the desired compatibility with a polymeric matrix. Generally, molar ratio of the first component oligomer to the third component aliphatic compound would be on the order of 2:1 to 10:1. The first component oligomer may be reacted with the second component dye and the third component aliphatic component in any order, or concurrently.

The third component aliphatic compound comprises an aliphatic moiety and a co-reactive functional group, which may the same or different than the co-reactive functional group of the second component dye. The aliphatic compound provides a pendent aliphatic group on the oligomeric dye that may improve the compatibility of the dye with a polymeric matrix. The aliphatic group may be linear or branched, saturated or unsaturated, containing 12 to 100 carbon atoms, and may contain caternary oxygen atoms. Useful aliphatic compounds include for example, long chain fatty alcohol, acids, acyl halides, amine and nitrites, such as Unilin™ polyethylene alcohols and Unicid™ polyethylene acids available from Baker Petrolite Corp., Tulsa, Okla. Also useful are poly(oxyalkylene) compounds such as poly(ethylene glycol) monomethyl ether, poly(propylene glycol) monomethyl ether such as the Carbowaxes™, amine-capped poly(ethylene glycol) such as Jeffamines™, and other functional aliphatic compounds known to the art. As the aliphatic moiety is chosen to provide compatibility with a particular polymer matrix, other organic moieties such as amides, urethanes, esters and the like may also be used. Where the polymer matrix is a polyolefin, Rₕ is preferably an alkyl group of 12 to 30 carbon atoms.

If desired, the first component oligomer may be reacted with the second component dye, in amounts such that some pendant reactive functional groups of the oligomer remain. These free unreacted functional groups may be subsequently reacted with a third component aliphatic compound also having a functional group A′ that is also co-reactive with the functional group of the oligomer. This sequence is depicted in the scheme below:

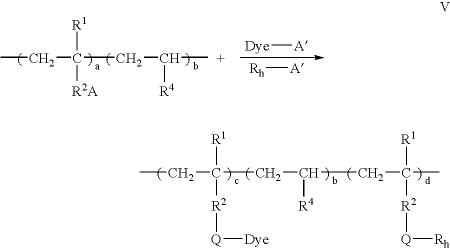

wherein R¹ is hydrogen, a C₁ to C₄ alkyl group, or a phenyl group; R² is a single bond or a divalent linking group that joins an ethylenically unsaturated group to reactive functional group A; each A and A′ is a reactive functional group, capable of reacting with a co-reactive functional group for the incorporation of a dye moiety and/or the aliphatic moiety, R⁴ is H or a C, to C₈ alkyl, Q is the resulting linking group formed by the reaction be the reactive and co-reactive functional groups, “Dye” is a fluorescent or non-fluorescent dye moiety; Rₕ is an aliphatic group that may be linear or branched, saturated or unsaturated, containing 12 to 100 carbon atoms, and may contain caternary oxygen atoms, d is at least one, b is zero to 100, c is at least one and b+c+d is 20 to 200, preferably 25 to 100. With respect to the oligomeric dye product above, it will be understood that the dye may further comprise polymerized monomer units of the type shown in Formula I, where the reactive functional group remains unreacted with either the second component dye or the third component aliphatic compound. It will be further understood that the polymerized monomer units of Formula VI may be in any order and may comprise random or block polymerized monomer units shown.

The resulting oligomeric dye may be represented by the formula:

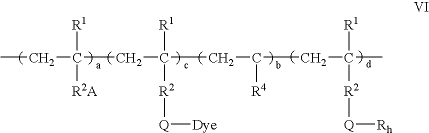

wherein R¹ is hydrogen, a C₁ to C₄ alkyl group, or a phenyl group; A is a reactive functional group, R² and Q are divalent linking groups, R⁴ is H or a C₁ to C₈ alkyl, “Dye” is a fluorescent or non-fluorescent dye moiety; Rₕ is an aliphatic group containing 12 to 100 carbon atoms and optionally caternary oxygen, a is zero to 20, c is at least one, b is zero to 100, d is at least one and a+b+c+d is 20 to 200. Preferably a, b, c and d are each at least one and a+b+c+d is 25 to 100.

If desired, a catalyst may be used to enhance the rate of reaction between the reactive and co-reactive functional groups. Metal catalysts such as dibutyltin dilaurate, butyltin oxide hydroxide, and dibutyltin diacetate are effective with alcohol-isocyanate combinations. Strong acids such as ethanesulfonic acid, trifluoroacetic acid and methanesulfonic acid are useful with azlactone-alcohol combinations and anhydride-alcohol combinations. Effective concentrations of the catalytic agents are from 0.01 to 5.00 weight percent, based on the concentration of the stoichiometrically-limiting reactant. Strong bases such as 1,8-diazabicylo[5.4.0]undec-7-ene (DBU), 1,5-diazabicylo[4.3.0] non-5-ene (DBN), and N-methyl-1,5,7-triazabicyclo[4.4.0]dec-5-ene may also be used.

Useful non-fluorescent dye moieties include azo, heterocyclic azo, anthraquinone, benzodifuranone, polycyclic aromatic carbonyl, polymethine, styryl, di- and tri-aryl carbonium, phthalocyanine, indigoid, quinophthalone, nito, nitroso, stilbene, formazan and sulfur dye moieties. Useful fluorescent dye moieties include coumarin, thioxanthene, xanthene, naphthalic acid derivatives, perylene, perylene imide, benzanthrone, benzothioxanthone, diketopyrrole, rhodamine, cationic methane, thioindigoid, naphthalimide and azomethine moieties.

The present invention produces oligomeric dyes useful as additives for thermoplastic polymers to impart color or fluorescent properties thereto. Thermoplastic polymers which may be used in the present invention include but are not limited to melt-processible polyolefins and copolymers and blends thereof, styrene copolymers and terpolymers (such as Kraton™), ionomers (such as Surlyn™), ethyl vinyl acetate (such as Elvax™), polyvinylbutyrate, polyvinyl chloride, metallocene polyolefins (such as Affinity™ and Engage™), poly(alpha olefins) (such as Vestoplast™ and Rexflex™), ethylene-propylene-diene terpolymers, fluorocarbon elastomers (such as THV™ from 3M Dyneon), other fluorine-containing polymers, polyester polymers and copolymers (such as Hytrel™), polyamide polymers and copolymers, polyurethanes (such as Estane™ and Morthane™), polycarbonates, polyketones, and polyureas.

Useful polyamide polymers include, but are not limited to, synthetic linear polyamides, e.g., nylon-6 and nylon-66, nylon-1,1, or nylon-12. It should be noted that the selection of a particular polyamide material might be based upon the physical requirements of the particular application for the resulting reinforced composite article. For example, nylon-6 and nylon-66 offer higher heat resistant properties than nylon-11 or nylon-12, whereas nylon-11 and nylon-12 offer better chemical resistant properties. In addition to those polyamide materials, other nylon materials such as nylon-612, nylon-69, nylon-4, nylon-42, nylon-46, nylon-7, and nylon-8 may also be used. Ring containing polyamides, e.g., nylon-6T and nylon-61 may also be used. Polyether containing polyamides, such as PEBAX polyamides (Atochem North America, Philadelphia, Pa.), may also be used.

Polyurethane polymers which can be used include aliphatic, cycloaliphatic, aromatic, and polycyclic polyurethanes. These polyurethanes are typically produced by reaction of a polyfunctional isocyanate with a polyol according to well-known reaction mechanisms. Commercially available urethane polymers useful in the present invention include: PN-04 or 3429 from Morton International, Inc., Seabrook, N.H., and X4107 from B.F.Goodrich Company, Cleveland, Ohio.

Also useful are polyacrylates and polymethacrylates which include, for example, polymers of acrylic acid, methyl acrylate, ethyl acrylate, acrylamide, methylacrylic acid, methyl methacrylate, n-butyl acrylate, and ethyl acrylate, to name a few.

Other useful substantially extrudable hydrocarbon polymers include polyesters, polycarbonates, polyketones, and polyureas. These materials are generally commercially available, for example: SELAR® polyester (DuPont, Wilmington, Del.); LEXAN® polycarbonate (General Electric, Pittsfield, Mass.); KADEL® polyketone (Amoco, Chicago, Ill.); and SPECTRIM® polyurea (Dow Chemical, Midland, Mich.).

Useful fluorine-containing polymers include crystalline or partially crystalline polymers such as copolymers of tetrafluoroethylene with one or more other monomers such as perfluoro(methyl vinyl)ether, hexafluoropropylene, perfluoro(propyl vinyl)ether; copolymers of tetrafluoroethylene with ethylenically unsaturated hydrocarbon monomers such as ethylene, or propylene.

Still other fluorine-containing polymers useful in the invention include those based on vinylidene fluoride such as polyvinylidene fluoride; copolymers of vinylidene fluoride with one or more other monomers such as hexafluoropropylene, tetrafluoroethylene, ethylene, propylene, etc. Still other useful fluorine-containing extrudable polymers will be known to those skilled in the art as a result of this disclosure.

Polyolefins represent a class of extrudable polymers that are particularly useful in the present invention. Useful polyolefins include the homopolymers and copolymers of olefins, as well as copolymers of one or more olefins and up to about 30 weight percent, but preferably 20 weight percent or less, of one or more monomers that are copolymerizable with such olefins, e.g., vinyl ester compounds such as vinyl acetate.

The olefins have the general structure CH₂=CHR⁵, where R is a hydrogen or an alkyl radical, and generally, the alkyl radical contains not more than 8 carbon atoms and preferably one to four carbon atoms. Representative olefins are ethylene, propylene, butylene, and butene-1. Representative monomers which are copolymerizable with the olefins include 1-butene, 1-octene, 1-hexene, 4-methyl-1-pentene, propylene, vinyl ester monomers such as vinyl acetate, vinyl propionate, vinyl butyrate, vinyl chloroacetate, vinyl chloropropionate, (meth)acrylic acid ester monomers, and their alkyl esters, amides, and nitriles such as methyl acrylate, ethyl acrylate, N,N-dimethyl acrylamide, methacrylamide, acrylonitrile, vinyl aryl monomers such as styrene, o-methoxystyrene, p-methoxystyrene, and vinyl naphthalene, vinyl and vinylidene halide monomers such as vinyl chloride, vinylidene chloride, vinylidene bromide, alkyl ester monomers of maleic and fumaric acid such as dimethyl maleate, diethyl maleate, vinyl alkyl ether monomers such as vinyl methyl ether, vinyl ethyl ether, vinyl isobutyl ether, 2-chloroethyl vinyl ether, and vinyl pyridine monomers.

Representative examples of polyolefins useful in this invention are polyethylene, polypropylene, polybutylene, poly 1-butene, poly(3-methylbutene), poly(4-methylpentene) and copolymers of ethylene with propylene, 1-butene, 1-hexene, 1-octene, 1-decene, 4-methyl-1-pentene and 1-octadecene 1.

Representative blends of polyolefins useful in this invention are blends containing polyethylene and polypropylene, low-density polyethylene and high-density polyethylene, and polyethylene and olefin copolymers containing the copolymerizable monomers, some of which are described above, e.g., ethylene and acrylic acid copolymers; ethyl and methyl acrylate copolymers; ethylene and ethyl acrylate copolymers; ethylene and vinyl acetate copolymers-, ethylene, acrylic acid, and ethyl acrylate copolymers, and ethylene, acrylic acid, and vinyl acetate copolymers.

The preferred polyolefins are homopolymers of ethylene and propylene and copolymers of ethylene and 1-butene, 1-hexene, 1-octene, 4-methyl-1-pentene, propylene, vinyl acetate, and methyl acrylate. A preferred polyolefin is a homopolymer, copolymer, or blend of linear low-density polyethylene (LLDPE). Polyolefins may be polymerized using Ziegler-Natta catalysts, heterogeneous catalysts and metallocene catalysts.

Carboxyl, anhydride, or imide functionalities may be incorporated into the first component oligomer by polymerizing or copolymerizing functional monomers, for example, acrylic acid or maleic anhydride, or by modifying a polymer after polymerization, for example, by grafting, by oxidation or by forming ionomers. These include, for example, acid modified ethylene vinyl acetates, acid modified ethylene acrylates, anhydride modified ethylene acrylates, anhydride modified ethylene vinyl acetates, anhydride modified polyethylenes, and anhydride modified polypropylenes. The carboxyl, anhydride, or imide functional polymers useful as the hydrocarbon polymer are generally commercially available. For example, anhydride modified polyethylenes are commercially available from DuPont, Wilmington, Del., under the trade designation BYNEL coextrudable adhesive resins.

The monomers of the first component oligomer, particularly the second monomers of Formula II, are selected to provide miscibility with a selected thermoplastic polymer. Miscibility and compatibility of the thermoplastic polymers and the oligomeric dye are determined by both thermodynamic and kinetic considerations. Common miscibility predictors for non-polar polymers are differences in solubility parameters or Flory-Huggins interaction parameters. For polymers with non-specific interactions, such as polyolefins, the Flory-Huggins interaction parameter can be calculated by multiplying the square of the solubility parameter difference by the factor (V/RT), where V is the molar volume of the amorphous phase of the repeated unit V=M/6 (molecular weight/density), R is the gas constant, and T is the absolute temperature. As a result, Flory-Huggins interaction parameter between two non-polar polymers is always a positive number. Thermodynamic considerations require that for complete miscibility of the thermoplastic polymer and the oligomeric dye (in the melt), the Flory-Huggins interaction parameter generally has to be very small (e.g. less than 0.002 to produce a miscible blend starting from 100,000 weight-average molecular weight thermoplastic polymer at room temperature). It is difficult to find polymer blends with sufficiently low interaction parameters to meet the thermodynamic condition of miscibility over the entire range of compositions. However, industrial experiences suggest that some blends with sufficiently low Flory-Huggins interaction parameters, although still not miscible based on thermodynamic considerations, form compatible blends.

The polymer composition can also contain additives, adjuvants, fillers, stabilizers, and the like, so long as such materials are not deleterious to the functions thereof. Stabilizers against thermal and UV degradation can include o-hydroxybenzophenones, cyanoacrylate esters, 2-(o-hydroxyphenyl)benzotriazoles, hindered amine light stabilizers (HALS), copolymerizable UV absorbers and the like. Further additives can include fillers, such as fumed silica, hydrophobic silica (U.S. Pat. Nos. 4,710,536 and 4,749,590), alumina, and natural and synthetic resins in particulate, flake or fibrous form. For various applications, foaming agents, such as low-boiling hydrocarbons; fluorinated materials; flame-retardants; anti-static agents; flow-control agents; and coupling agents for additives, such as silanes, may be added. When additives are present, they are added in amounts consistent with the known functional uses of such additives.

It is also within the scope of this invention to add optional adjuvants such as thixotropic agents; plasticizers; toughening agents such as those taught in U.S. Pat. No. 4,846,905; antioxidants; flow agents; flatting agents; binders; blowing agents; fungicides; bactericides; surfactants; glass and ceramic beads; and reinforcing materials, such as woven and nonwoven webs of organic and inorganic fibers, such as polyester, polyimide, glass fibers and ceramic fibers; and other additives as known to those skilled in the art can be added to the compositions of this invention. These can be added in an amount effective for their intended purpose; typically, amounts up to about 10 parts by weight of adjuvant per total weight of formulation can be used.

Shaped articles (e.g., fibers, films and molded or extruded articles) can be made, e.g., by blending or otherwise uniformly mixing the oligomeric dye and the thermoplastic polymer, for example by intimately mixing the oligomer with pelletized or powdered polymer, and melt extruding the mixture into shaped articles such as pellets, fibers, or films by known methods. The oligomer can be mixed per se with the polymer or can be mixed with the polymer in the form of a “masterbatch” (concentrate) of the oligomer in the polymer. Masterbatches typically contain from about 10% to about 25% by weight of the oligomeric dye. Also, an organic solution of the oligomer may be mixed with the powdered or pelletized polymer, the mixture dried to remove solvent, then melted and extruded into the desired shaped article. Alternatively, molten oligomer (as a compound(s) or masterbatch) can be injected into a molten polymer stream to form a blend just prior to extrusion into the desired shaped article.

The amount of oligomer in the thermoplastic polymer is that amount sufficient to produce a shaped article desired degree of coloration (color density) and/or fluorescence. Preferably, the amount of oligomer will be from about 0.01 to 50 parts by weight, based on 100 parts by weight of the shaped article.

The oligomeric dyes find use as fibers, fabrics, canvas markings, roll-up signs, barrel wraps, cone sleeves, truck markings, license plates, safety vests, pavement marking paints and tapes, reflective films, and other articles where flexible materials having dye durability are desired. These materials preferably are fluorescent. The materials of the present invention are particularly useful in safety applications and devices, such as in fluorescent traffic signs, where dye stability and durability are highly valued.

### EXAMPLES

The invention will be further explained by the following illustrative examples, which are intended to be non-limiting.

Glossary Table

| | | |
|---|---|---|
| Descriptor | Description, Formula and/or Structure | Availability |
| Dye-1 Yellow-Green Fluorescent Dye | 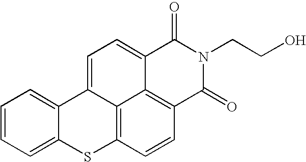 | See preparation below |
| Dye-2 Blue Dye | 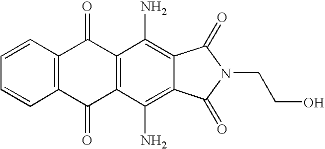 | See preparation below |
| Dye-3 Red Dye | 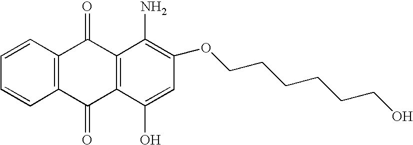 | See preparation below |
| Dye-4 Red Fluorescent Dye | 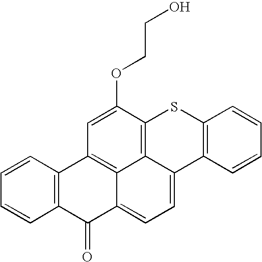 | See preparation below |
| 1-amino-2-bromo-4- hydroxyanthroquinone | 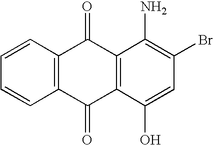 | Aceto Chemical Co., Lake Success, NY |
| 1,4-diamino-2,3-dicyano anthraquinone | 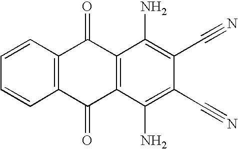 | Aceto Chemical Co., Lake Success, NY |
| 2-amino-1-ethanol | NH₂(CH₂)₂OH | Sigma-Aldrich |
| 2-aminothiophenol | 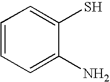 | Sigma-Aldrich |
| 4-chloronaphthalic anhydride | 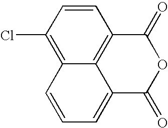 | Acros Organics, Pittsburgh, PA |
| DMF | Dimethylformamide; (CH₃)₂NC(O)H | Sigma-Aldrich |
| ethylene carbonate | 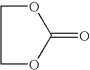 | Sigma-Aldrich |
| 2-hydroxy benzanthrone | 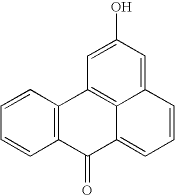 | Can be prepared according to U.S. Pat. No. 4,036,859 (Example 1 and 2) |
| sodium nitrite | NaNO₂ | Sigma-Aldrich |
| tetraethyl ammonium iodide | (C₂H₅)₄NI | Sigma-Aldrich |
| triethyl amine | N(C₂H₅)₃ | Sigma-Aldrich |
| Tetramethylene sulfone (sulfolane) | 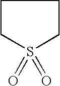 | Sigma-Aldrich |
| 1,2-dichlorobenzene | 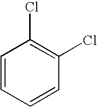 | Sigma-Aldrich |
| Methanol | CH₃OH | Sigma-Aldrich |
| 1-methyl-2-pyrollidinone | 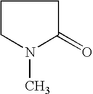 | Sigma-Aldrich |
| 1,6-hexane-diol | HO(CH₂)₆OH | Sigma-Aldrich |
| Potassium Carbonate | K₂CO₃ | |
| A-C 5120, A-C 540, A-C 580 | Ethylene Acrylic Acid (EAA) Oligomer | Allied Signal |
| | -MW˜2000 | |
| Butyl tin oxide hydroxide | CH₃(CH₂)₃Sn(═O)OH | Sigma-Aldrich |
| catalyst | | |
| Phenpol | 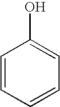 | Sigma-Aldrich |
| N-bromosuccinimide (NBS) | 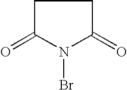 | Sigma-Aldrich |

Preparation 1: Synthesis of Dye-1 (Yellow Green Fluorescent Dye)

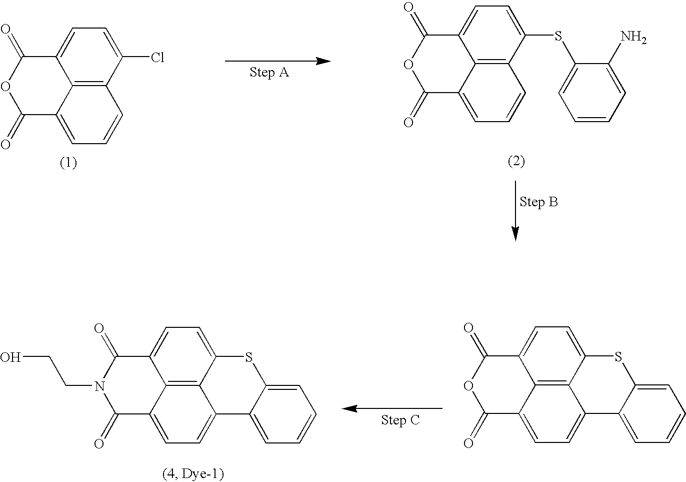

Step A: Preparation of (2)

A 1000 mL round bottom flask equipped with a heating mantle, stirrer and dropping funnel was charged with 4-chloronaphthalic anhydride ((1), 125 g, 0.54 moles), potassium carbonate (36.9 g, 0.27 moles), 215 g isopropyl alcohol, and 322 g sulfolane and heated to about 50° C. 2-aminothiophenol (73.9 g moles) was added dropwise so that the temperature was maintained below 80° C. The mixture was then heated to 90° C. and held for 3 hours. The mixture was cooled to 15° C. and the resulting orange precipitate was recovered via filtration with a Buchner funnel. The solid was resuspended in DI water (470 g) and then filtered using a Buchner funnel. The solid was dried and analysis via ¹³C NMR confirmed the structure (2).

Step B: Preparation of (3)

A 5000 mL round bottom flask fitted with a dropping funnel and immersed in an ice-water cooling bath was charged with (2) (241.0 g, 0.75 moles) and 3600 g DMF. HCl (600 g, concentrated) was slowly added dropwise, keeping the temperature below 15° C. An aqueous solution of sodium nitrite (52.5 g, 21%) was added and the reaction mixture was stirred for two hours, maintaining the temperature below 5° C. CuSO₄5H₂O (3.0 g, 0.012 moles) was added and a mild exotherm occurred. The cooling bath was then replaced with a heating mantle, and nitrogen gas evolved as the temperature was slowly elevated to 100° C. and held for 3 hours. The mixture was cooled to ambient temperature (˜25° C.) and filtered using a Buchner funnel. The resulting solid was resuspended in DI water (1000 g) and filtered again using a Buchner funnel. The solid (3) was dried to yield 171 g (75% of the theoretical material).

Step C: Preparation of (4)

A 3000 mL round bottom flask fitted with a condenser and mechanical stirrer was charged with (3) (304 g, 1.0 moles), 2-amino-1-ethanol (63 g, 1.01 moles) and DMF (1400 g) and the ensuing mixture was heated to reflux (˜155° C.) for 3 hours. After it was determined that no starting material remained (via thin layer chromatography (TLC) in ethyl acetate) the mixture was cooled to 80° C. and 1000 g DI water was added, keeping the temperature between 70-80° C. until all the water was added. The resulting suspension was then cooled to room temperature and filtered using a Buchner funnel. The solid material was resuspended in 1000 g DI water and filtered again using a Buchner funnel. The yield of resulting Dye-I material (4) was 302 g. ¹³C NMR analysis confirmed the product structure.

Preparation 2: Synthesis of Dye-2 (Blue dye)

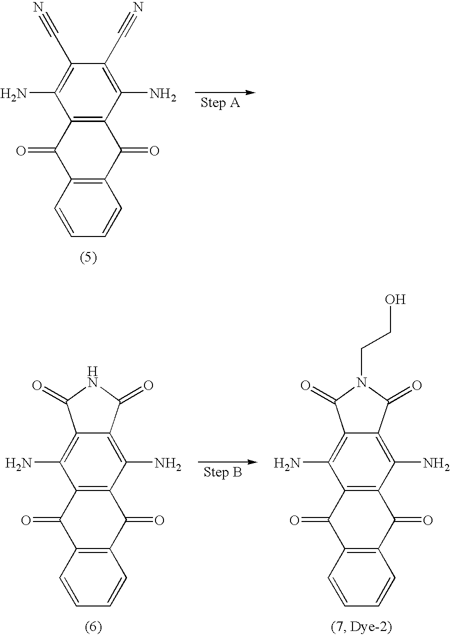

Step A: Preparation of (6)

A 1 liter three neck round bottom flask was charged with 630 g sulfuric acid. The solution was stirred and heated to 80° C. 1,4-diamino-2,3-dicyano anthraquinone ((5)123.4 g 0.43 moles) was added to the flask, using a water bath and heating mantle to control the reaction temperature at 140-150° C. Once all of the anthraquinone was added, the reaction temperature was held at 150° C. for one hour. The reaction mixture was then cooled to 40° C. and 255 g water was added, using cooling to control the exotherm to below 50° C. and then cooled to room temperature.

The reaction mixture was filtered through a glass frit funnel. The resulting solid filtrate was washed with water. About 500 g additional water was added and the solid was filtered again. The resulting solid (6) was air dried and used in the following steps.

Step B: Preparation of (7)

A one liter three neck round bottom flask was charged with 60 g (0.22 moles) of the (6), 320 g 1,2-dichlorobenzene and 26.6 g (0.44 moles) 2-amino-1-ethanol (both available from Aldrich). A dean-stark trap and condenser, and a mechanical stirrer were used. The batch was heated to about 120° C., distilling out a small amount of solvent and water. Gradually the batch temperature was raised to 150° C. and held for three hours. TLC (in ethyl acetate) showed no residual (6).

The batch was cooled to room temperature and about 400 g methanol was added. The resulting mixture was filtered through a Buchner funnel. About 500 g. water and 25 g. concentrated HCl was added to the resulting solid. The mixture was stirred and filtered, and then repeated. The resulting blue solid (Dye-2, 7) was air-dried and the structure verified by ¹³C NMR analysis.

Preparation 3: Synthesis of Dye-3 (Red Dye)

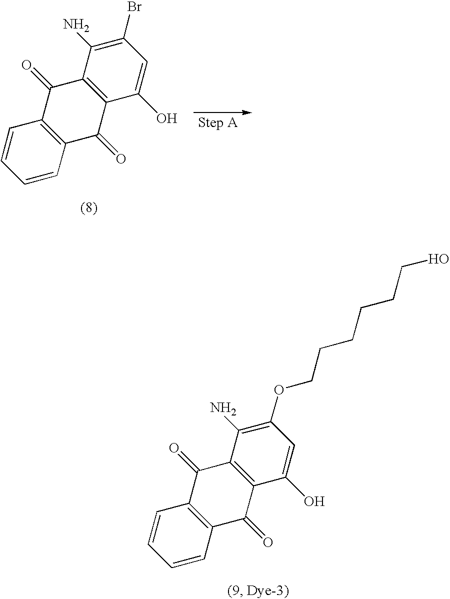

Step A: Preparation of (9)

A three neck 250 ml round bottom flask was charged with 25 g (0.079 moles) of 1-amino-2-bromo-4-hydroxy anthraquinone (8), 54.5 g (0.55 moles) of 1-methyl-2-pyrollidinone, 92 g (0.78 moles) 1,6-hexane-diol, 8.8 g (0.94 moles) phenol, and 12 g (0.086 moles) potassium carbonate. The batch was heated to 120° C. and held for 12 hours. TLC (in ethyl acetate) found no residual starting material.

The reaction was cooled to 50° C. and 150 g methanol was added. The reaction was then cooled to room temperature and filtered with a Buchner funnel. 300 g methanol was added to the resulting solid and then stirred and filtered. The resulting solid product was dried in an oven at 100° C. The yield was 19.8 g. ¹³C NMR analysis shows the material was 94% pure of Dye-3 (9).

Preparation 4: Synthesis of Dye-4 (RED FLUORESCENT Dye)

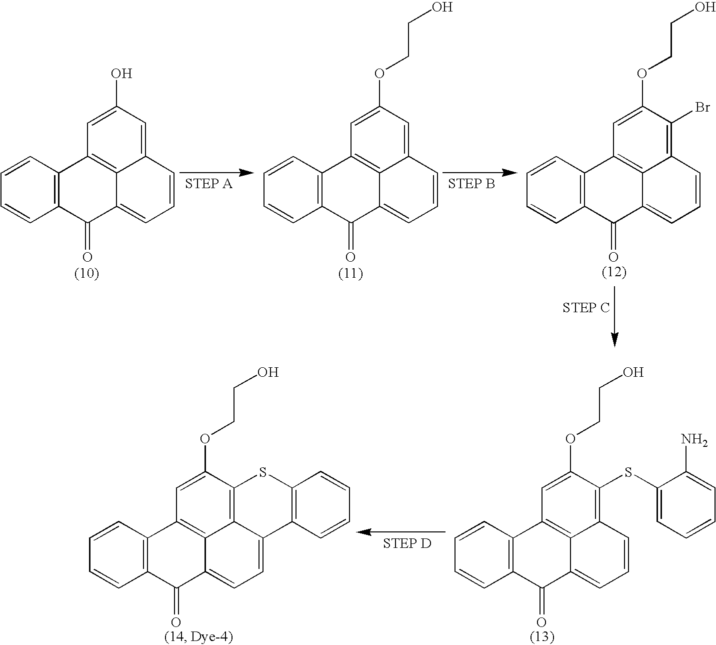

Step 1: Preparation of (11)

A 1 L three neck round bottom flask equipped with a mechanical stirrer and thermometer was charged with 2-hydroxy benzanthrone ((10), 75.0 g; 0.3 mole), ethylene carbonate (35.0 g; 0.4 mole), tetraethylammonium iodide (18.0 g; 0.07 mole) and dimethylformamide (300.0 g). The ensuing mixture was heated at reflux for 15 hours, and additional ethylene carbonate (25.0 g; 0.3 mole) and tetraethylammonium iodide (8.0 g; 0.03 mole). The resulting mixture was cooled to ambient temperature and DI water was added (200.0 g). The precipitate was filtered, allowed to air dry and recrystallized in isopropyl alcohol (yielding 70 g. of (11)).

Step 2: Preparation of (12)

A 1 L three neck round bottom flask equipped with a mechanical stirrer and condenser was charged with 11 (70.0 g; 0.24 mole), NBS (53.0 g; 0.3 mole) and dimethylformamide (500.0 g). The ensuing stirred mixture was heated to about 55° C. for 3 hours, cooled to ambient temperature and DI water (500.0 g) was added. The aqueous mixture was extracted with chloroform (250.0 g). This organic extract was then washed three times with DI water (500.0 g aliquots), chloroform was removed using a rotary evaporator, and the resulting yellow material (12) was oven dried (75 g; 88% yield).

Step 3: Preparation of (13)

A 500 mL three neck round bottom flask equipped with a mechanical stirrer and condenser was charged with 12 (7.3 g; 0.02 mole), sodium carbonate (2.1 g; 0.02 mole), 2-aminothiophenol (2.8 g; 0.022 mole) and dimethylformamide (25 g). The ensuing mixture was stirred and heated at reflux for 3 hours, cooled to ambient temperature, and filtered. The yellow solid material was washed with DI water (20.0 g), filtered and oven dried to yield (13) (5.1 g; 62% yield).

Step 4: Preparation of (14)

A 1 L three neck round bottom flask equipped with a mechanical stirrer and dropping funnel was charged with (13) (20.6 g; 0.05 mole) and dimethylformamide (300.0 g). The ensuing mixture was cooled to 20° C. using an ice bath, and HCl (55.0 g; concentrated) was slowly added dropwise, keeping the temperature at or below 20° C. With continued cooling, an aqueous solution of sodium nitrite (24.0 g; 16.6%) was added dropwise over a period of one hour, keeping the temperature at or below 5° C. Upon completion of the addition, the cooled mixture was stirred for an additional 2 hours. The cooling bath was removed and replaced with a heating mantle. Cu(SO₄)₂ (0.3 g) was added to the mixture and a temperature of 130° C. was maintained for 3 hours. The mixture was then cooled to ambient temperature and filtered. The filtered solid was re-slurried with DI water (200.0 g), filtered and oven dried to yield Dye-4 (14) (14.0 g; 71% yield; mp 301-303° C.). Structure and purity (>90%) were confirmed using ¹³C NMR.

### Example 1

### Oligomeric Fluorescent Yellow-Green Dye

A 12 liter flask equipped with a mechanical stirrer, condenser and temperature probe was charged with 8683 g of A-C 5120 ethylene acrylic acid oligomer. The flask was then charged with 865 g of Dye-1 (yellow-green Fluorescent dye) and 11.6 g of butyl tin oxide hydroxide catalyst. The reaction mixture was then heated with stirring. The reaction mixture became molten and began to evolve water around 150° C. The reaction was continued at 240° C. for two to four hours until completion. The reaction was determined to be complete when none of the dye (dye-1) could be detected by thin layer chromatography (TLC). The reaction was cooled to 150° C. and the molten mixture drained to an aluminum pan. The oligomeric dye was be crushed or ground to provide a useable form.

### Example 2

### Oligomeric Blue Dye

The procedure of Example 1 was followed using 50 g of A-C 5120 EAA and 16.8 g Dye-2 and 0.43 g of butyl tin oxide hydroxide catalyst.

### Example 3

### Oligomeric Red Dye

The procedure of Example 1 was followed using 50 g. of A-C 5120 EAA and 18.7 g dye-3 and 0.43 g. of butyl tin oxide hydroxide catalyst.

### Example 4

### Oligomeric Fluorescent Red Dye

The procedure of Example 1 was followed using 900 g of A-C 5120 EAA and 100 g Dye-4 and 1.0 g. butyl tin oxide hydroxide catalyst.

### Example 5

### Oligomeric Fluorescent Yellow-Green Dye With Aliphatic Co-Reactant

50 g. of A-C 5120 ethylene acrylic acid oligomer was mixed with 5 g. of dye-1 and 40 g. polyethylene glycol monomethyl ether (average Mn ca 550) and 0.2 g. of dibutyl tin oxide hydroxide in a 250 ml three-neck flask. The mixture was to 150° C. and then agitated with a mechanical stirrer. The mixture was heated to 240-250° C. and held for five hours, after which time TLC showed none of the starting dye present. The reaction was cooled to 150° C. and the yellow-green fluorescent oligomeric dye (which contains a co-reacted polyether compatibilizer) was drained.

The examples above all use A-C 5120 EAA oligomer from Allied-Signal. This material has an acid number of 120 and is approximately 15 weight % acrylic acid. Other oligomers in this family include A-C 540 (about 5% acid) and A-C 580 (about 10% acid). These oligomeric materials can be used in place of the A-C 5120, while using a stoichiometric equivalent amount of co-reactive functional dye and catalyst.

1. A process for preparing an oligomeric dye comprising the step of reacting:
a) an oligomeric addition polymer having one or more pendant reactive functional groups; and
b) a dye having a co-reactive functional group.

2. The process of claim 1 wherein said oligomeric addition polymer has a molecular weight (Mw) of from about 500 to 15,000 M_{w}.

3. The process of claim 1 wherein said oligomeric addition polymer has a degree of polymerization of <200.

4. The process of claim 1 wherein said pendent reactive functional groups of said oligomeric addition polymer are selected from hydroxyl, secondary amino, oxazolinyl, oxazolonyl, acetylacetonyl, carboxyl, isocyanato, epoxy, aziridinyl, acyloyl halide, and cyclic anhydride groups.

5. The process of claim 1, wherein said oligomeric addition polymer comprises polymerized monomer units of the formula: 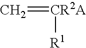
wherein R¹ is hydrogen, a C₁ to C₄ alkyl group, or an aryl group; R² is a single bond or a divalent linking group that joins an ethylenically unsaturated group to reactive functional group A; and A is a reactive functional group, capable of reacting with a co-reactive functional group for the incorporation of a dye moiety.

6. The process of claim 5 wherein said R² group is selected from the group consisting of a single bond, —R³—, —CO₂—, —CONH-, and combinations thereof in which R³ is an alkylene group having 1 to 6 carbon atoms, a 5- or 6-membered cycloalkylene group having 5 to 10 carbon atoms, or an alkylene-oxyalkylene in which each alkylene includes 1 to 6 carbon atoms, or is a divalent aromatic group having 6 to 16 carbon atoms.

7. The process of claim 5 wherein said oligomeric addition polymer further comprises monomer units selected from the group consisting of olefins, and ethylenically unsaturated esters of carboxylic acids.

8. The process of claim 5, wherein said oligomeric addition polymer further comprises a monomer unit selected from the group consisting of ethylene, propylene, butylene, styrene, vinyl toluene, vinyl acetate, and mixtures thereof??

9. The process of claim 1 wherein said oligomeric addition polymer comprises
a) from 1 to 25 parts by weight of polymerized monomer units derived from of an ethylenically-unsaturated monomer having a reactive functional group; and
b) from 50 to 99 parts by weight of polymerized monomer units derived from an olefinic monomer.

10. The process of claim 1 where the molar ratio of said reactive functional groups of said oligomeric addition polymer to said co-reactive functional groups of said dye is from 1:1 to 1:10.

11. The process of claim 5, wherein said oligomeric addition polymer comprises oligomers of the formula: 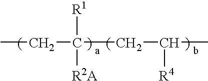
wherein R¹ is hydrogen, a C₁ to C₄ alkyl group, or a phenyl group; R² is a single bond or a divalent linking group that joins an ethylenically unsaturated group to reactive functional group A; A is a reactive functional group, capable of reacting with a co-reactive functional group for the incorporation of a dye moiety, R⁴ is H or a C₁ to C₈ alkyl, a is at least one and a+b is 20 to 200.

12. The process of claim 1 wherein said dye having a co-reactive functional group is a fluorescent dye.

13. The process of claim 12 wherein said fluorescent dye having a co-reactive functional group is a coumarin, thioxanthene, xanthene, naphthalic acid derivatives, perylene, perylene imide, benzanthrone, benzothioxanthone, diketopyrrole, rhodamine, cationic methane, thioindigoid, naphthalimide and azomethine dye, and mixtures thereof.

14. The process of claim 1 wherein said dye having a co-reactive functional group is a non-fluorescent dye selected from the group consisting of azo, heterocyclic azo, anthraquinone, benzodifuranone, polycyclic aromatic carbonyl, polymethine, styryl, di- and tri-aryl carbonium, phthalocyanine, indigoid, quinophthalone, nito, nitroso, stilbene, formazan and sulfur dyes, and mixtures thereof.

15. The process of claim 5 wherein said monomer units comprise ethylenically unsaturated carboxylic acids or reactive derivatives thereof.

16. The process according to claim 15 wherein said ethylenically unsaturated carboxylic acids are selected from the group consisting of acrylic acid, methacrylic acid, fumaric acid, maleic acid, crotonic acid, itaconic acid, and cinnamic acid or reactive derivative thereof.

17. The process of claim 1 wherein said oligomer and said dye are reacted in the presence of a catalyst.

18. The process of claim 17, wherein said catalyst is selected from the group consisting of dibutyl tin oxide, dibutyl tin hydroxide, butyl tin oxide hydroxide, stannous octoate, lithium ricinoleate, and bismuth neodecanoate.

19. An oligomeric dye comprising the formula: 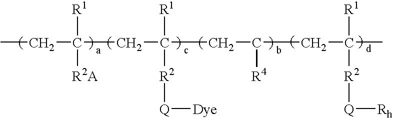
wherein R¹ is hydrogen, a C₁ to C₄ alkyl group, or a phenyl group; A is a reactive functional group, R² and Q are divalent linking groups, R⁴ is H or a C₁ to C₈ alkyl, “Dye” is a fluorescent or non-fluorescent dye moiety; Rₕ is an aliphatic group containing 12 to 100 carbon atoms and optionally caternary oxygen, a is zero to 20, c is at least one, b is zero to 100, d is at least one and a+b+c+d is 20 to 200.

20. The dye of claim 19 wherein Rₕ is a poly(oxyalkylene) group.

21. The dye of claim 19 wherein a, b, c, and d are each at least one and a+b+c+d is 25 to 100.

22. The dye of claim 19 wherein Rₕ is an alkyl group of 12 to 30 carbon atoms.

23. An oligomeric dye of the formula: 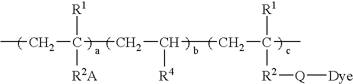
wherein R¹ is hydrogen, a C₁ to C₄ alkyl group, or a phenyl group; R² is a single bond or a divalent linking group that joins an ethylenically unsaturated group to reactive functional group A; R⁴ is H or a C₁ to C₈ alkyl, Q is a divalent linking group, “Dye” is a fluorescent or non-fluorescent dye moiety, a is zero to 20, b is zero to 100, c is at least one and a+b+c is 20 to 200.

24. The oligomeric dye of claim 23 wherein a is 1 to 20, b is 1 to 100, c is at least one and a+b+c is 25 to 100.
